(19) United States
(12) Patent Application Publication
(10) Pub. No.: US 2007/0203007 A1
(43) Pub. Date: Aug. 30, 2007

(54) STRUCTURE OF INTERFOLDING MACHINE WITH ADJUSTABLE CUT-OFF

(75) Inventor: Alessandro DE MATTEIS, Lucca (IT)

Correspondence Address: DENNISON, SCHULTZ & MACDONALD, 1727 KING STREET, SUITE 105, ALEXANDRIA, VA, 22314, US

(73) Assignee: MTC- MACCHINE TRASFORMAZIONE CARTA S.R.L., Lucca (IT)

(21) Appl. No.: 11/675,437

(22) Filed: Feb. 15, 2007

(30) Foreign Application Priority Data
Feb. 28, 2006 (EP) 06004052.4

(51) Int. Cl. B31B 1/14

(52) U.S. Cl. 493/360

(57) ABSTRACT

An interfolding machine (100) having a modular structure and with variable cut-off, having a frame (21) comprising a first plate (21a) and a second plate (21b), parallel to each other, interconnected by means of beams (25). Between the plates (21a and 21b) folding rollers (8 and 9), means for moving (10) and an overlap roller (6), are arranged. Each plate (21a, or 21b), has a complementary shape to a respective upper plate (31a, or 31b). The higher plates (31a and 31b) are connected by means of beams (35) among one another. Between the plates (31a and 31b) instead the cutting roller (16), the transfer roller (5) and the cutter (17) with the blade (3) are arranged. This way, a modular portion (30) is formed removable independently from a main portion (20) of the frame. Alternatively, the removable portion (30) can comprise the only cutting roller (16) and the cutter (17) with the blade (3). Alternatively, the only transfer roller (5) may be provided. The advantage of the invention is that the removable portion brings with it gearings, bearings, supports, etc. of the substituted rollers, and it is exchanged with another equivalent but with different cut-off with a machine stop that is very short. The removable portion (30) can be slidingly mounted on longitudinal guides (36). This assists its removal from the working position, and provides a change with another removable portion (30) provided with rollers (16, 17 and 5) of diameter corresponding to the length of the interfolded sheets of the final stack.

### FIELD OF THE INVENTION

The present invention relates to the production of paper material in stacks of interfolded sheets, and, in particular, it relates to a structure of interfolding machine adapted to process sheets of different length.

### BACKGROUND OF THE INVENTION

As well known, in the paper converting industry a variety of types is used of machines and of processes for making paper tissues, paper towels and similar articles in stacks of a certain height of interfolded sheets.

They are obtained stacking the sheets in an “interfolded” way, i.e. at each fold a wing of the previous sheet and a wing of a next stack sheet engage with each other. This way, when drawing a sheet from a package, at the moment of the use, also a wing of a next stack sheet is dragged up to protruding from the package, with subsequent practical employment for certain types of users. Among possible interfolding ways the L-type, with 2 folds (single fold), or the Z or W types, respectively with 3 and 4 folds (multi fold), are known.

The interfolding machines use one or more webs of paper, which from one or more large rollers and which are cut into sheets and then supplied offset with respect to one another on folding counter-rotating rollers.

More precisely, the webs are cut into sheets by means of cutting rollers that interact alternatively, with relative counter-support blades. In case of L-type interfolding the webs are cut to form a shifted succession of sheets coming preferably from two different directions. Then, the sheets coming from either directions are fed in an alternated way to the folding rollers, so that each sheet coming from the first direction is overlapped with a portion of the sheet coming from the second direction, and vice-versa.

The sheets coming from the two directions, in order to be overlapped in the way above described, adhere to the respective folding rollers by a holding system comprising either suction holes or mechanical clamps. Then, the downstream portion of each sheet leaves a respective folding roller at the contact line between the two rollers, held by the other folding roller, which is holding already the upstream portion of the previous sheet.

In case of Z or W type interfolding, or even in case of much more folds, all called “multifold”, as disclosed in U.S. Pat. No. 3,490,762 the interfolding method can be similar to what described above, with the difference that The overlapping step between two successive sheets is carried out immediately after the cut and a stream of partially overlapped sheets reaches the folding rollers from a single direction.

The folding rollers have a circumference multiple to the length of the not overlapped portion of two overlapped sheets. Therefore, the stack of sheets adds an interfolded sheet after a fraction of turn of the folding rollers. This parameter determines the size of the folded sheet being stacked, i.e. the width of the interfolded sheets packages. In view of that, one of the parameters of reference for an interfolding machine is the stack width.

Another reference parameter for an interfolding machine is the length of the sheets, also called cut-off. In particular, in the interfolding machines the length of the interfolded sheets that eventually form the stack of final product is responsive to the circumference of the cutting rollers and to the angular distance among the cutting blades. In other words, the cutting length is fixed and is determined univocally by the circumference of the cutting roller or rollers.

By changing the length of the sheets, or cut-off, it is possible to keep the same pack width, by adjusting the number of interfolded panels.

It can be in particular preferable to adjust the cut-off without changing the pack width, leaving the user a variety of choices for making packs.

Machines exist capable of adjusting the cut-off using cutting rollers with several retractable knives (see EP1514677), and that can selectively exit or withdraw thus changing the cutting length: this type of rollers, however, is not appropriate for interfolding machines of “multifold” type, which normally provide one stream of sheets of paper. In fact, in these machines it is not enough to adjust the cut-off by changing only the number of knives, but it would be necessary to change other parts of the machine.

Presently, an interfolding machine of type “multifold” allows to produce interfolded sheets of a single length, with an extremely stiff process, and for each sheet length a different machine is required.

### SUMMARY OF THE INVENTION

It is therefore a feature of the present invention to provide an interfolding machine structure that provides to produce stacks of interfolded sheets with sheets of different length even if maintaining, in particular, a same pack width, in an easy and cheap way, causing the whole production process to be flexible and then of differentiating the production.

It is also a feature of the invention to provide a structure of interfolding machine for changing as desired the length of the sheets and the pack width independently.

These and other objects are accomplished by the structure of interfolding machine, according to the present invention, having a frame comprising:
a feeding section where at least one web of paper is fed at a first speed,
a cutting section comprising:
   at least one cutting roller on which at least one blade acts adapted to divide the web of paper into sheets of determined length;
   at least one transfer roller adapted to convey forward at said first speed the sheets cut in turn by the cutting roller;
an interfolding section at which the sheets of paper coming from the cutting section travel at a second speed less than the first speed, said interfolding section comprising:
   means for partially overlapping the sheets suitable to form an overlapped portion between two consecutive sheets exploiting the difference between the first and the second speed,
   folding means comprising folding rollers, said folding means being adapted to arrange said partially overlapped sheets in a determined interfolded configuration causing the sheets to form underneath a stack of product;
a separating section where a stack of interfolded sheets is separated from a next stack and withdrawn from the area of process through separating means;
whose main feature is that said cutting section comprises a portion having a modular structure removable integrally from said frame for being replaced with an equivalent portion but adapted to work with different cut-off.

In particular, the portion of the cutting section that is removable integrally can comprise:
at least the cutting roller;
at least the transfer roller;
the cutting roller and the transfer roller.

Advantageously, the means for partially overlapping the sheets comprise an overlapping roller adapted to cooperate with the transfer roller. In particular, the transfer roller rotates at the first speed whereas the overlapping roller rotates at the second speed in order to deposit on the overlapping roller the overlapped sheets according to a determined overlapping ratio.

Furthermore, means for moving can be provided adapted to convey the partially overlapped sheets in a zone arranged between the means for overlapping and the folding rollers.

The interfolding machine of modular type can provide a single paper path, where a single web of paper coming from a large roller is cut into sheets that are fed shifted on the counter rotating folding rollers. The overlapping step between two successive sheets is carried out immediately after the cut and the succession of partially overlapped sheets reaches the folding rollers from a single direction.

According to the invention, with a single interfolding machine having more equivalent removable portions, but each portion with rollers of different diameter and then with different cut-off, it is possible to provide stacks of interfolded sheets of different length and then to obtain different interfolding types, i.e. with a different number of portions of overlapped sheets. Therefore, such interfolding machine is highly flexible.

Advantageously, the removable portions, each with rollers of different diameter, are mounted on a automatic introduction/extraction machine, for example a carousel with horizontal axis, capable of receiving more removable portions and introducing/extracting selectively a portion of interfolding machine at a time.

In addition to what above defined, a first removable portion at the cutting section and a second removable portion at the interfolding section can be advantageously provided, said first and said second portion being removable independently. This way, a much more wide variety can be obtained of solutions at the choice of the user to provide an interfolding machine that is highly flexible, with possibility of changing as desired both the length of the sheet and the pack width independently.

Advantageously, the or each removable portion is slidingly mounted on guides arranged longitudinally with respect to the frame.

The removable portion of the interfolding machine comprises preferably two plates, or sides, connected by means of transversal beams that extend parallel to the folding roller, and containing laterally the components of the machine. The frame of the interfolding machine comprises also two sides, each consisting of one or more parallel plates interconnected by means of transversal beams, to which the other components of the machine are connected, at least one of said sides having an opening or a recess with complementary shape for introducing the or each removable portion.

### BRIEF DESCRIPTION OF THE DRAWINGS

Further characteristic and the advantages of the interfolding machine, according to the invention, will be made clearer with the following description of an exemplary embodiment thereof, exemplifying but not limitative, with reference to the attached drawings, in which like reference characters designate the same or similar parts, throughout the figures of which:

FIG. 1 shows diagrammatically a cross sectional view of an interfolding machine of the type with a single paper path;

FIG. 2 shows diagrammatically a perspective view of an interfolding machine, according to the invention;

FIG. 3 shows a perspective view of the interfolding machine of FIG. 1 with the removable modular portion in a position of extraction from the working position;

FIG. 4 shows in detail a perspective view of the removable portion;

FIG. 5 shows in detail a perspective view of a removable portion equivalent to that of FIG. 4, but with rollers of different dimension;

FIG. 6 shows a perspective view of the interfolding machine of FIG. 1 with the removable modular portion of FIG. 5 in a position of introduction into the working position;

FIG. 7 shows diagrammatically a perspective view of an interfolding machine, with replaced removable modular portion,

FIG. 8 shows diagrammatically a perspective view of an exemplary embodiment of the interfolding machine of FIG. 1.

### DESCRIPTION OF A PREFERRED EXEMPLARY EMBODIMENT

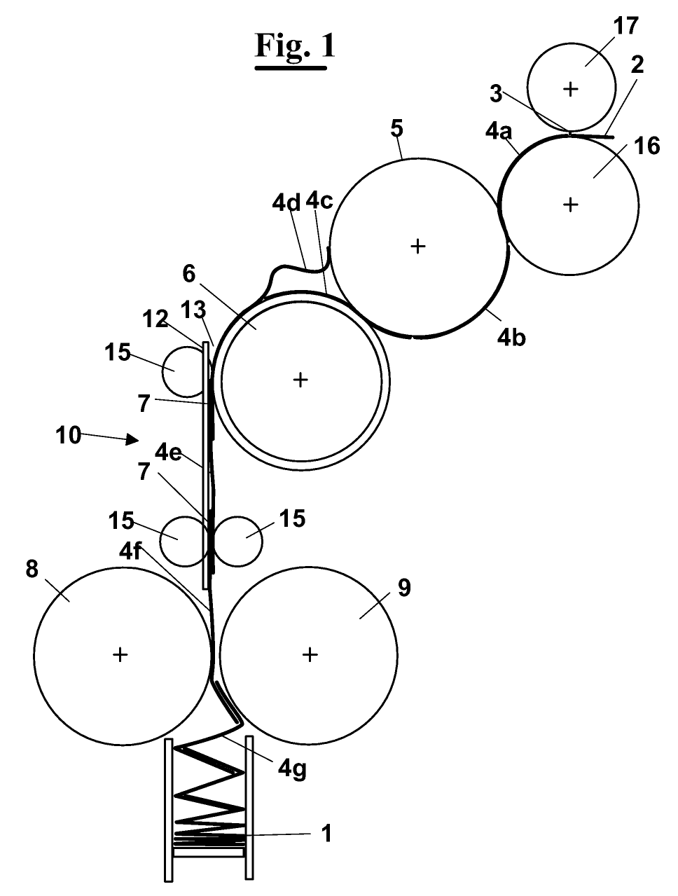

With reference to FIG. 1, an interfolding machine of sheet material for making a stack of interfolded sheets 1 uses at least one web 2 of material to interfold, for example paper, non woven fabric fed by means of feeding rollers 41-44. The web 2 is cut by a blade 3 of a cutting roller 17 into sheets of predetermined length. In particular, the blade 3 acts on a cutting roller 16. The cutter, in addition to a roller type, can be also formed without fixed blades and having alternated movement with respect to the cutting roller 16.

The cut sheets, all alike, which are carried along the machine are indicated as 4a, 4b, 4c, 4d, 4e, 4f, 4g, starting from the cutting point under the cutter 3 up to the point where they are interfolded.

As well known, at first, the cut sheets 4a, 4b proceed on a first roller 5 that rotates at a first speed. Then they pass on a second roller 6, called “overlap” roller, which rotates at a second speed less than the first. This way, owing to this speed difference a sheet 4c travelling quicker is conveyed under the sheet downstream 4d travelling slower, which is raised at the tail by means of air blows not shown. The overlapping portion of the sheets, indicated as 7, between the two sheets 4c and 4d extends for about a third of their length, in order to form, eventually, an interfolding pattern so-called to Z type, at interfolding rollers 8 and 9, falling on a stack 1.

Among the “overlap” roller 6 and the interfolding rollers 8,9 a conveying system 10 not described in detail is provided, adapted to convey the sheets 4d,4e,4f, partially overlapped, in a corresponding conveying portion. In this section, so-called interfolding section, the sheets travel all at the second speed.

More precisely, the operation of the overlapping system is the following. The overlap roller 6 turns at the second speed, i.e. slower than the transfer roller 5. This causes the sheet 4c, transferred by the transfer roller up to overlap roller 6 owing to vacuum systems not shown, to take the shape of a wave. When the tail of the head sheet 4d, which is still attached to the transfer roller 5, passes the channel existing between overlap roller 6 and transfer roller 5, the head of the sheet upstream from 4c is transferred by the transfer roller 5 to the overlap roller 6 and the overlapping is carried out.

The length of sheets 4a-4g is determined by the diameter of the cutting roller 16. In order to adjust the length of the sheets, or cut-off, it is necessary to adjust at least the diameter of the cutting rollers 16. This would require however to make, according to the prior art, a very complex and long operation of maintenance, which would require to disassemble large part of the machine.

Furthermore, according to the type of transfer, it could be necessary to change also the transfer roller 5.

Alternatively, in case of cutting rollers with variable cut-off it is necessary to change at least the transfer roller.

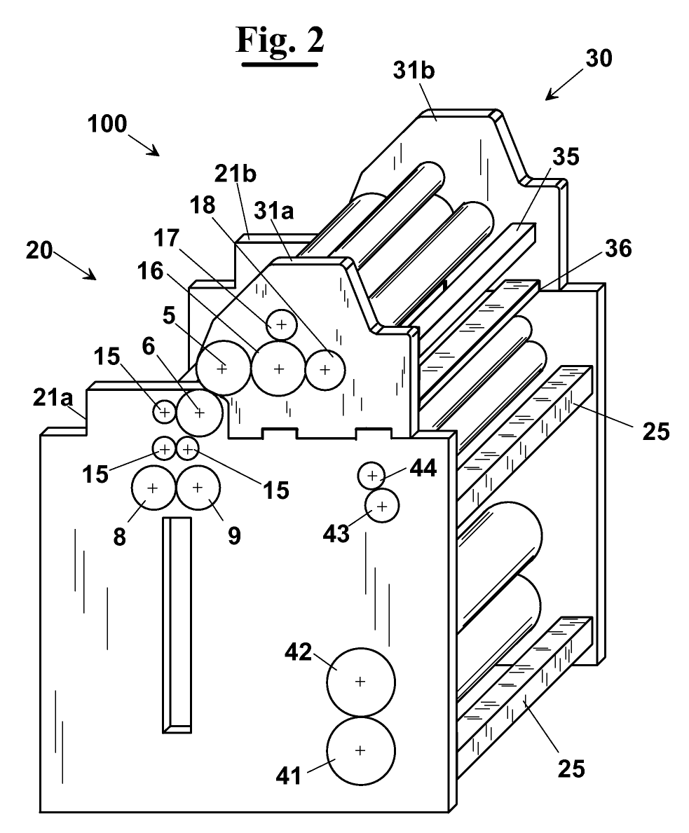

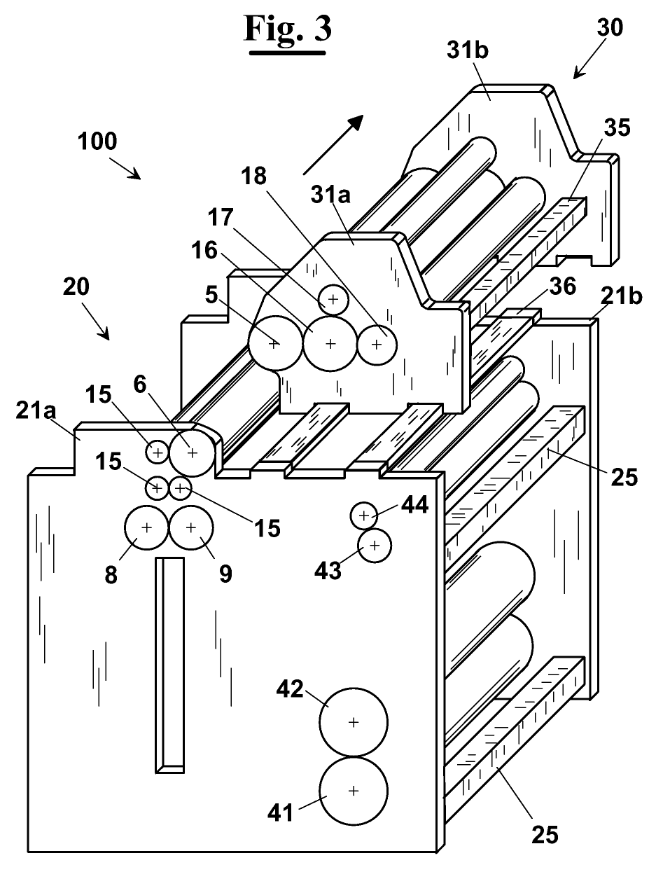

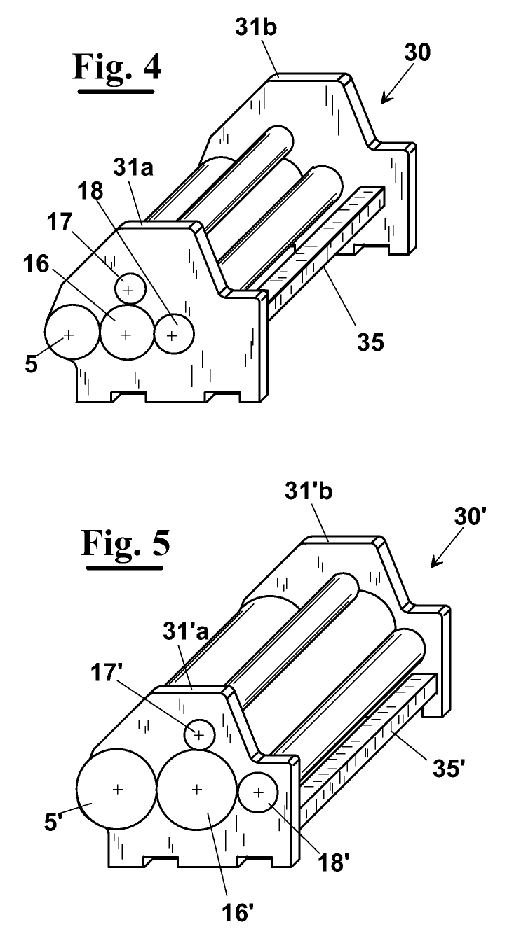

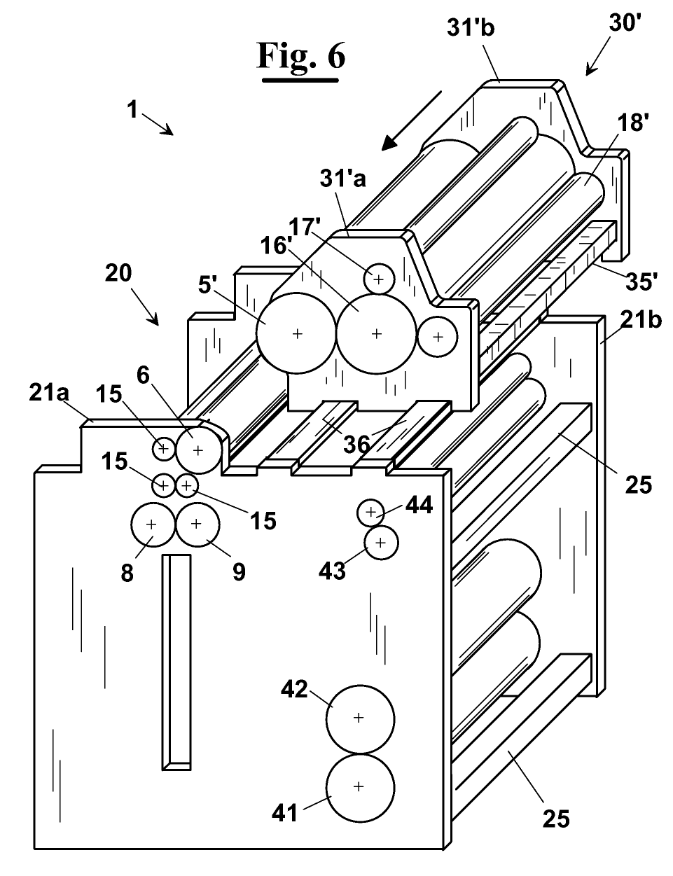

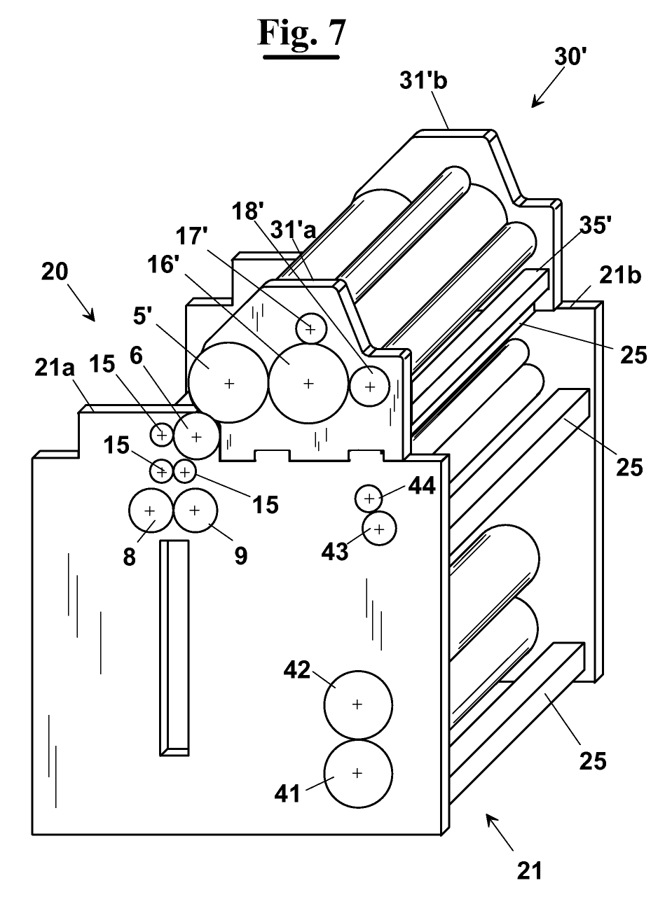

With reference to FIG. 2, an interfolding machine, according to the present invention, has a modular structure, adapted to solve this problem. In particular, the interfolding machine 100 provides a frame 21 (visible alone in FIG. 3) comprising a first plate 21a and a second plate 21b, parallel to it, interconnected by means of beams 25. Between the plates 21a and 21b the folding rollers 8 and 9, the means for moving 10 and the overlap roller 6 are arranged.

Each plate 21a, or 21b, has a complementary shape to a respective upper plate 31a, or 31b. Upper plates 31a and 31b shown in figures from 1 to 3 are connected by means of beams 35. Between the plates 31a and 31b, instead, the cutting roller 16, the transfer roller 5 and the cutter 17 with blade 3 are arranged.

This way, a modular portion 30 is formed that is removable independently from a main portion 20 of the frame.

Obviously, in the essence of the present invention, removable portion 30 can comprise, in a way not shown, only cutting roller 16 and cutter 17 with blade 3. Alternatively, it can comprise only the transfer roller.

The advantage of the invention is that the removable portion brings gearing, bearings, supports, etc. of the replaced rollers and is therefore replaceable with a very short machine stop.

The removable portion 30 can be slidingly mounted on a longitudinal guide 36 (FIG. 3). This assists its removal from the working position (FIG. 2), to change it with another removable portion 30′ having rollers 16′, 17′ and 5′ of diameter corresponding to the length of the interfolded sheets of the final stack.

As said above, in fact, the length of the interfolded sheets of the final product stack 1 is responsive to the circumference of the cutting roller 16. The modular structure, in the way above described for interfolding machine, allows to replace quickly the cutting roller 16 and/or the transfer roller 5 and then to change the type of the final product.

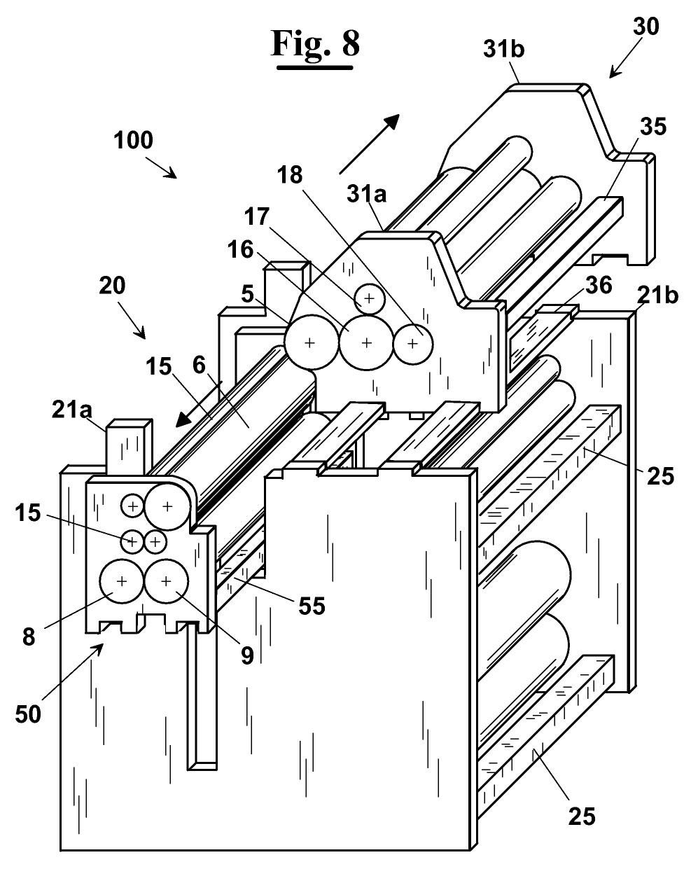

In a exemplary embodiment shown in FIG. 8 a second portion 50 is provided removable integrally from the frame of the machine 100. In this case, removable portion 50 comprises the overlap roller 6, the means for moving 15 and the folding rollers 8 and 9. This allows to change at the same time both the length of the sheets and the folding width, i.e. the pack 1 width.

Similarly, to what described for portion 30 also portion 50 can be slidingly mounted on longitudinal guide not shown in FIG. 8.

In a way not shown in the figures, the removable portions 30 and/or 50, each with rollers of different diameter, can be mounted on a automatic introducing/extracting machine, of easy construction by a skilled person, for example a carousel with horizontal axis, capable of receiving more removable portions and extracting selectively a portion of interfolding machine at a time.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. The means and materials for carrying out various disclosed functions may take a variety of alternative forms without departing from the invention. It is to be understood that the phraseology or terminology employed herein is for the purpose of description and not of limitation.

1. Interfolding machine having a frame comprising:
a feeding section where at least one web of paper is fed at a first speed,
a cutting section comprising:
at least one cutting roller on which at least one blade acts adapted to divide the web of paper into sheets of determined length;
at least one transfer roller adapted to convey forward at said first speed the sheets cut in turn by the cutting roller;
an interfolding section at which the sheets of paper coming from the cutting section travel at a second speed less than the first speed, said interfolding section comprising:
means for partially overlapping the sheets suitable to form an overlapped portion between two consecutive sheets exploiting the difference between the first and the second speed,
folding means comprising folding rollers, said folding means being adapted to arrange said partially overlapped sheets in a determined interfolded configuration causing the sheets to form underneath a stack of product;
a separating section where a stack of interfolded sheets is separated from a next stack and is withdrawn from the area of process through separating means;
characterised in that said cutting section comprises a portion having a modular structure removable integrally from said frame for being replaced with an equivalent portion that is adapted to work with different cut-off.

2. Interfolding machine, according to claim 1, wherein said integrally removable cutting section comprises:
at least said cutting roller;
at least said transfer roller;
said cutting roller and said transfer roller.

3. Interfolding machine, according to claim 1, wherein said means for partially overlapping said sheets comprises an overlapping roller adapted to cooperate with said transfer roller, said transfer roller rotating at said first speed and said overlapping roller rotating at said second speed in order to deposit on said overlapping roller said overlapped sheets according to a determined overlapping ratio.

4. Interfolding machine, according to claim 3, wherein conveying means are provided adapted to convey said partially overlapped sheets into a portion set between said means for overlapping and said folding rollers.

5. Interfolding machine, according to claim 1, wherein a plurality of removable portions is provided, each with rollers of different diameter, mounted on a automatic introduction/extraction machine, said introduction/extraction machine being capable of receiving more removable portions and introducing/extracting selectively a portion at a time in said interfolding machine.

6. Interfolding machine, according to claim 1, wherein a first removable portion at said cutting section and a second removable portion at said interfolding section are provided, said first and said second portion being removable independently.

7. Interfolding machine, according to claim 1, wherein said removable portion is slidingly mounted on guides arranged longitudinally with respect to said frame.

8. Interfolding machine, according to claim 1, wherein said separating means adapted to enter said completed stack for separating it from the next stack being formed, and vertical guides containing said stack are mounted on carriages that can approach/move away from each other along a direction transversal to said frame for arrange them at a operative distance responsive to the size of the rollers mounted on said machine.

9. Interfolding machine, according to claim 1, wherein said removable portion comprises two plates, or sides, parallel to each other and interconnected by means of transversal beams parallel to said cutting roller, components of the machine

10. Interfolding machine, according to claim 1, wherein said frame comprises two sides, each consisting of one or more parallel plates interconnected by means of transversal beams, to which the remainder of said components of the machine are connected, at least one of said sides having an opening or a recess with complementary shape for introducing said removable portion.
